(19) United States
(12) Patent Application Publication
(10) Pub. No.: US 2026/0288590 A1
(43) Pub. Date: Sep. 24, 2026

(54) MANAGING RETRIEVAL OF STORAGE DEVICE TELEMETRY DATA

(71) Applicant: Dell Products L.P., Round Rock, TX (US)

(72) Inventors: PHANINDRA BHARGAV TALASILA, Georgetown, TX (US); ADOLFO SANDOR MONTERO, Pflugerville, TX (US); XIAOMEI ZHU MILLER, Round Rock, TX (US); IBRAHIM SAYYED, Georgetown, TX (US)

(21) Appl. No.: 19/085,741

(22) Filed: Mar. 20, 2025

(51) Int. Cl. G06F 11/14

(52) U.S. Cl. CPC G06F 11/1417; G06F 2201/805

(57) ABSTRACT

Methods and systems for managing operation of a data processing system are disclosed. To manage the data processing system, a management controller of the data processing system may retrieve telemetry data, based on a telemetry data capture event, from a storage device using a side band channel. The telemetry data may be generated by the storage device based on operation of the storage device and stored on the storage device. Once obtained, the management system may provide the telemetry data to a remote management system. The management controller may obtain, for example, a remediation package from the remote management system based on the telemetry data for use in updating operation of the storage device and/or other components of the data processing system.

### FIELD

Embodiments disclosed herein relate generally to managing operation of a data processing system. More particularly, embodiments disclosed herein relate to managing operation of the data processing system by using a management controller to obtain telemetry data from a storage device hosted by the data processing system and communicating the telemetry data to a remote management system.

### BACKGROUND

Computing devices may provide computer-implemented services. The computer-implemented services may be used by users of the computing devices and/or devices operably connected to the computing devices. The computer-implemented services may be performed with hardware components such as processors, memory modules, storage devices, and communication devices. The operation of these components and the components of other devices may impact the performance of the computer-implemented services.

### BRIEF DESCRIPTION OF THE DRAWINGS

Embodiments disclosed herein are illustrated by way of example and not limitation in the figures of the accompanying drawings in which like references indicate similar elements.

FIGS. 1A-1C show diagrams illustrating a system in accordance with an embodiment.

FIGS. 2A-2B show interaction diagrams in accordance with an embodiment.

FIG. 3 shows a flow diagram illustrating a method in accordance with an embodiment.

FIG. 4 shows a block diagram illustrating a data processing system in accordance with an embodiment.

### DETAILED DESCRIPTION

Various embodiments will be described with reference to details discussed below, and the accompanying drawings will illustrate the various embodiments. The following description and drawings are illustrative and are not to be construed as limiting. Numerous specific details are described to provide a thorough understanding of various embodiments. However, in certain instances, well-known or conventional details are not described in order to provide a concise discussion of embodiments disclosed herein.

Reference in the specification to “one embodiment” or “an embodiment” means that a particular feature, structure, or characteristic described in conjunction with the embodiment can be included in at least one embodiment. The appearances of the phrases “in one embodiment” and “an embodiment” in various places in the specification do not necessarily all refer to the same embodiment.

References to an “operable connection” or “operably connected” means that a particular device is able to communicate with one or more other devices. The devices themselves may be directly connected to one another or may be indirectly connected to one another through any number of intermediary devices, such as in a network topology.

In general, embodiments disclosed herein relate to methods and systems for managing operation of a data processing system. The data processing systems may provide computer-implemented services to any type and number of other devices and/or users of the data processing systems. The computer-implemented services may include any quantity and type of such services.

To provide the computer-implemented services, a data processing system may host any number and/or types of storage devices. A storage device of the storage devices may include, for example, a solid-state drive that utilizes non-volatile memory express (NVMe) to provide its functionality.

While operating, the storage device may generate data (e.g., telemetry data) regarding operation of the storage device. The telemetry data may include, for example, error logs, storage device health data, performance metrics, and/or any other information. The telemetry data may be obtained by a processor of the data processing system and used to manage operation of the data processing system. For example, a remediation process (e.g., storage device firmware update, storage resource recovery, etc.) may be initiated based telemetry data that indicates that the storage device is not in a desired operating state.

However, an ability to manage operation of the data processing system using the telemetry data may be limited when the storage device is not in the desired operating state. For example, the processor may not be able to access data (e.g., startup data) hosted by the storage device while the data processing system is booting due to data corruption, firmware corruption, flash memory failures, and/or any other causes. Consequently, the data processing system may not be booted to a desired state in which the processor may be operably connected to the storage device (e.g., for obtaining the telemetry data relevant to the undesired operating state) and/or other hardware components (e.g., a network module usable to communicate the telemetry data to a remote entity).

To modify operation of the data processing system in an event of compromise and/or reduced functionality of at least a portion of the hardware resources, the data processing system may host a management controller that may operate independently from the hardware resources and may be distinct from and adapted to manage the hardware resources. For example, the management controller may operate during the booting process (e.g., regardless of an outcome of the booting process) and/or while the hardware resources may be in a potentially compromised state.

Thus, to improve a likelihood that the data processing system may be managed using telemetry data regarding a storage device of the data processing system, the management controller may obtain the telemetry data from the storage device via a side band channel based on an occurrence of a telemetry data capture event.

Once obtained, the management controller may provide the telemetry data to a remote entity (e.g., a management system, a remote back-end service, etc.) using an out-of-band communication channel. The management system may identify a management action to perform to update operation of the data processing system based, at least in part, on the telemetry data. For example, the management controller may receive a remediation package (e.g., updated firmware for the storage device, instructions to recover data, etc.) from the management system. By doing so, operation of the data processing system may be updated to place the hardware resources in a desired operation state.

In an embodiment, a method for managing operation of a data processing system is provided. The method may include: (i) identifying, by a management controller of the data processing system, an occurrence of a telemetry data capture event for telemetry data regarding operation of a storage device of hardware resources of the data processing system; (ii) in response to the telemetry data capture event: (a) obtaining, by the management controller via a side band channel, the telemetry data from the storage device while the hardware resources are not in a desired operating state; (b) providing, by the management controller, the telemetry data to a management system using an out-of-band communication channel; (c) updating, cooperatively between the management controller and the management system, operation of the data processing system to place the hardware resources in a desired operating state; and (d) providing computer-implemented services using the updated data processing system.

The telemetry data capture event may be based on an inability of a processor of the hardware resources to access data hosted by the storage device while the data processing system is booting, the data being required for completion of a startup of the data processing system.

Identifying the occurrence of the telemetry data capture event may include: (i) identifying, by the processor, an occurrence of an error event for the storage device, the error event preventing desired operation of the storage device; and (ii) identifying, by the management controller, that the processor is unable to complete a startup of the data processing system due to the occurrence of the error event.

The telemetry data may be: (i) generated by the storage device based on operation of the storage device, and (ii) stored on the storage device.

The telemetry data may include at least one type of data selected from a group consisting of: (i) error logs; (ii) storage device health data; and (iii) performance metrics.

Updating operation of the data processing system may include: (i) obtaining, by the management controller and from the management system, a remediation package via the out-of-band communication channel, the remediation package being based, at least in part, on the telemetry data; and (ii) updating, by the management controller, operation of the data processing system using the remediation package.

The data processing system may include hardware resources and a network module adapted to separately advertise network endpoints for the management controller and the hardware resources of the data processing system, the network endpoints being usable by a remote system to address communications to the hardware resources using an in-band communication channel and the management controller using an out-of-band communication channel.

The management controller and the network module may be on separate power domains from the hardware resources so that the management controller and the network module are operable while the hardware resources are inoperable.

The out-of-band communication channel may run through the network module, and an in-band communication channel that services the hardware resources also runs through the network module.

The network module may host a transmission control protocol/internet protocol (TCP/IP) stack to facilitate network communications via the out-of-band communication channel.

In an embodiment, a non-transitory media is provided. The non-transitory media may include instructions that when executed by a processor cause the computer-implemented method to be performed.

In an embodiment, a system is provided. The system may include the non-transitory media and a processor, and may perform the computer-implemented method when the computer instructions are executed by the processor.

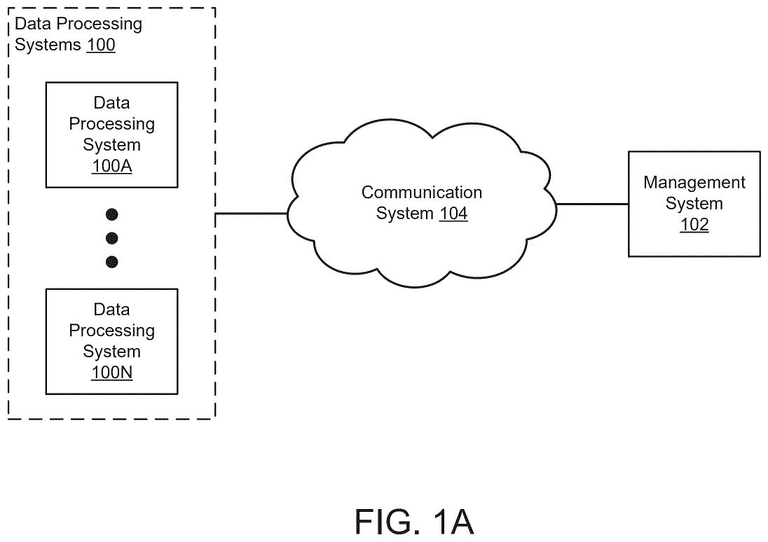

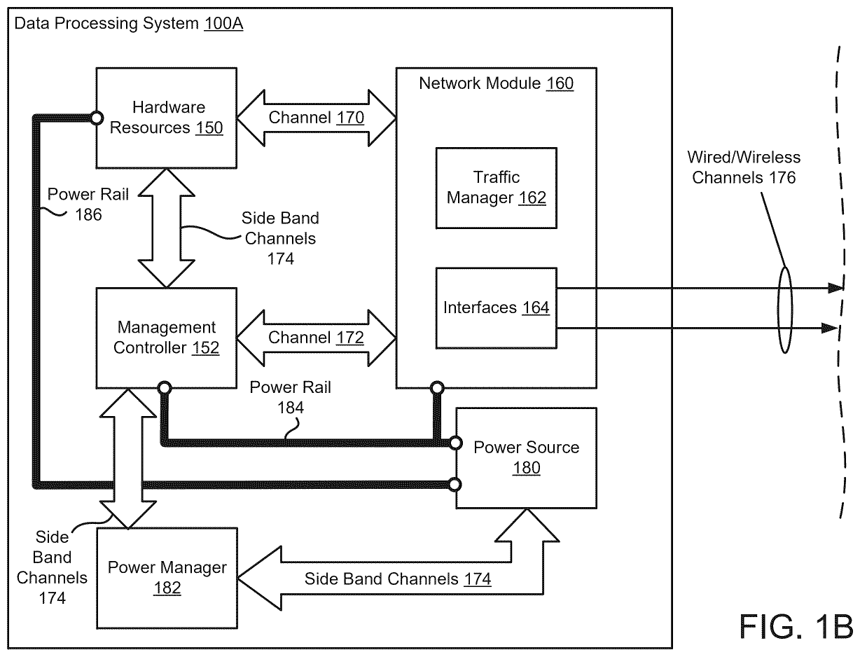

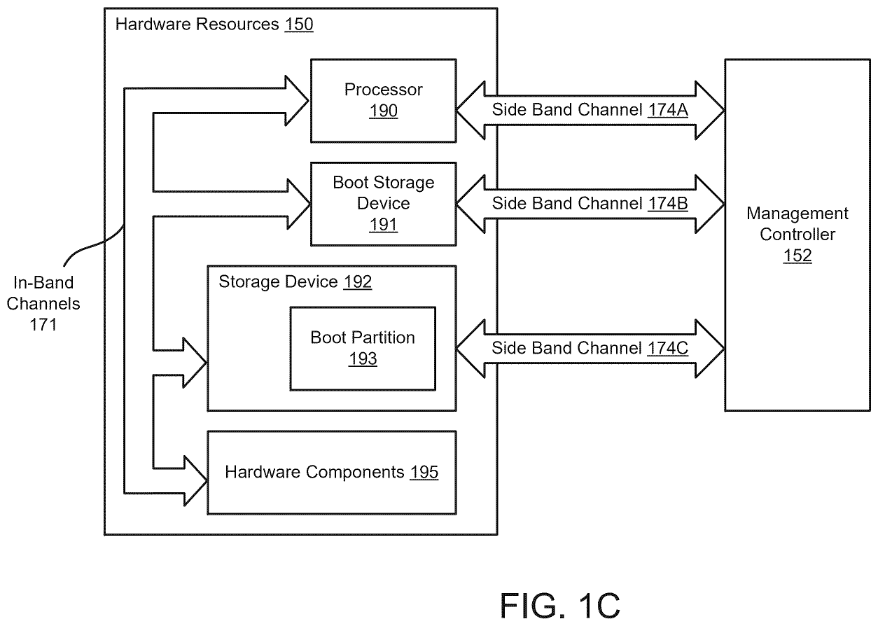

Turning to FIG. 1A, a block diagram illustrating a system in accordance with an embodiment is shown. The system shown in FIG. 1A may provide for management of data processing systems that may provide, at least in part, computer-implemented services (e.g., to user of the system and/or devices operably connected to the system).

The system may include any number of data processing systems 100 (e.g., computing devices) that may each include any number of hardware components (e.g., processors, memory modules, storage devices, communication devices, etc.). The hardware components may support execution of any number and types of applications (e.g., software components). Changes in available functionalities of the hardware and/or software components may provide for various types of different computer-implemented services to be provided over time. Refer to FIG. 1B for additional details regarding data processing systems 100.

The computer-implemented services may include any type and quantity of computer-implemented services. The computer-implemented services may include, for example, database services, data processing services, electronic communication services, and/or any other services that may be provided using one or more computing devices. The computer-implemented services may be provided by, for example, data processing systems 100, management system 102, and/or any other type of devices (not shown in FIG. 1A). Other types of computer-implemented services may be provided by the system shown in FIG. 1A without departing from embodiments disclosed herein.

The computer-implemented services may be provided at least in part, by hardware resources of data processing systems 100. The hardware resources may include any number and/or types of storage devices. A storage device of the storage devices may include, for example, a solid-state drive that utilizes non-volatile memory (e.g., NAND flash memory) and a data transfer protocol (e.g., non-volatile memory express (NVMe)) to provide its functionality. To provide its functionality, the storage device may further include, for example, storage resources (e.g., flash memory cells), a controller (e.g., to manage operations of the storage device), an interface (e.g., to facilitate communication between the storage device and the processor), and/or any other components.

The storage device may host any number and/or types of data that may be used to provide at least a portion of the computer-implemented services. For example, the storage device may host an image of an operating system, application data (e.g., software programs), files (e.g., documents, images, etc.), startup data (e.g., that may be stored in a boot partition of the storage device), and/or any other information.

Furthermore, the storage device may generate telemetry data that may be based on operation of the storage device. The generated telemetry data may subsequently be stored on the storage device (e.g., on storage resources of the controller of the storage device and/or on the storage device). The telemetry data may include, for example, error logs, event logs, storage device health data, performance metrics, and/or any other information. For example, the controller of the storage device may initiate the telemetry data to be generated in response to an identified error event (e.g., system crash, panic event, etc.). The telemetry data may subsequently be used by a management entity (e.g., via debugging) to update operation of the storage device and/or other hardware components of the data processing system.

However, an ability to manage operation of the data processing system using the telemetry data may be limited when the storage device is not in the desired operating state. For example, a processor may not be able to access data (e.g., startup data) hosted by the storage device while the data processing system is booting due to data corruption, firmware corruption, flash memory failures, and/or any other causes. Consequently, the data processing system may not be booted to a desired state in which the processor may be operably connected to the storage device (e.g., for obtaining the telemetry data relevant to the undesired operating state) and/or other hardware components (e.g., a network module usable to communicate the telemetry data to a remote entity).

To modify operation of the data processing system in an event of compromise and/or reduced functionality of at least a portion of the hardware resources, the data processing system may host a management controller that may operate independently from the hardware resources and may be distinct from and adapted to manage the hardware resources. For example, the management controller may operate during the booting process (e.g., regardless of an outcome of the booting process) and/or while the hardware resources may be in a potentially compromised state.

Furthermore, the data processing system may include a network module that may advertise a network endpoint for the management controller (e.g., that may be different from a network endpoint of the hardware resources) that may enable the management controller to communicate with a remote system (e.g., management system 102) using an out-of-band communication channel.

In general, embodiments disclosed herein relate to systems, devices, and methods for managing operation of a data processing system. To manage the operation of a data processing system, the management controller may obtain the telemetry data from the storage device via a side band channel based on an occurrence of a telemetry data capture event. The telemetry data capture event may be based, for example, on an inability of the data processing system to be booted to a desired operating state.

For example, while attempting to boot the data processing system, the processor may identify an error event for the storage device that may prevent desired operation of the storage device. The error event may be identified, for example, by basic input/output system (BIOS) firmware and based on a boot failure (e.g., CPU hang), an SSD initialization failure, a self-monitoring and reporting technology (SMART) error, data corruption, and/or any other events. Accordingly, the management controller may identify that the processor is unable to complete the startup of the data processing system due to the occurrence of the error event. For example, the management controller may identify that the processor is unable to complete the startup by receiving a notification from the processor (e.g., BIOS) that indicates that the telemetry data is to be retrieved from the storage device, monitoring results of processes performed by the processor to identify the occurrence of the error event, and/or via any other processes.

Additionally, the management controller may the telemetry data capture event based on an identification that the hardware resources may be in a potentially compromised state. For example, the data processing system may be subject to attacks by a malicious entity. As a result, at least a portion of services provided by the data processing system may be negatively impacted. For example, the data obtained from the storage device may be manipulated by corrupted components (e.g., malware), operation of the hardware resources may be impaired, and/or any other negative effects may limit desired use of the telemetry data of the storage device.

Thus, to improve a likelihood that the data processing system may be managed using the telemetry data regarding the storage device of the data processing system, the management controller may obtain the telemetry data from the storage device via a side band channel based on an occurrence of a telemetry data capture event (e.g., independently from any of the in-band components). To do so, the management controller may interact directly with the storage device (e.g., a controller of the storage device and/or using an interface provided by the storage device). to request and/or retrieve the telemetry data.

Once obtained, the management controller may provide the telemetry data to a remote entity (e.g., a management system, a remote back-end service, etc.) using an out-of-band communication channel. The management system may identify a management action to perform to update operation of the data processing system based, at least in part, on the telemetry data. For example, the management controller may receive a remediation package (e.g., updated firmware for the storage device, instructions to recover data, etc.) from the management system. By doing so, operation of the data processing system may be updated to place the storage device and/or other hardware resources in a desired operation state.

To provide the above noted functionality, the system may include data processing systems 100, and management system 102. Each of these components is discussed below.

Data processing systems 100 may include any number of data processing systems (e.g., 100A-100N) that may individually and/or cooperatively provide at least a portion of the computer-implemented services. Any of data processing systems 100 may include in-band components (e.g., hardware resources), out-of-band components (e.g., management controller, network modules, etc.), and functionality that may allow the out-of-band components to communicate with management system 102 via an out-of-band communication channel.

While providing the at least a portion of the computer-implemented services, a data processing system (e.g., 100A) of data processing systems 100 may communicate with and/or obtain information from management system 102. For example, data processing system 100A may obtain instructions relevant to updated storage device software (e.g., an updated firmware version), implementing a data recovery policy, management requests to modify operation of the hardware resources (e.g., installing new applications), and/or any other information. Data processing system 100A may subsequently perform actions based on the information obtained from management system 102 to update operation of data processing system 100A.

Management system 102 may, as discussed above, provide remote management services. Management system 102 may include, for example, a second data processing system operated an owner of data processing systems 100. To provide the remote management services, management system 102 may interact with data processing systems 100 to obtain and/or provide information (e.g., data) relevant to operation of data processing systems 100. For example, management system 102 may generate and provide a data recovery policy to a data processing system of data processing systems 100, evaluate telemetry data regarding operation of a storage device of the data processing system, obtain a remediation package based on the evaluation and/or the telemetry data, provide the remediation package to the data processing system, and/or provide any other services to manage operation of data processing systems 100.

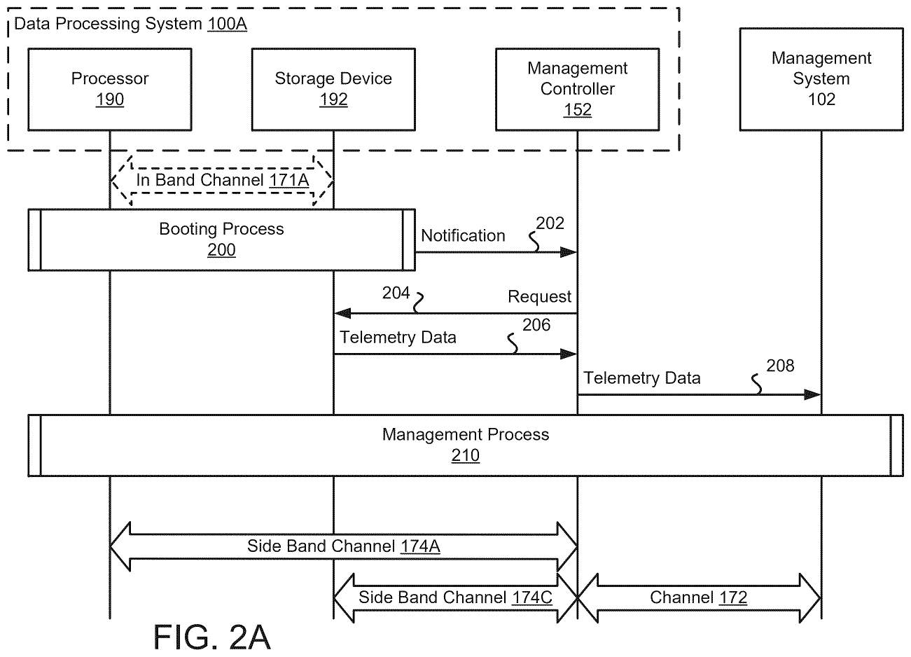

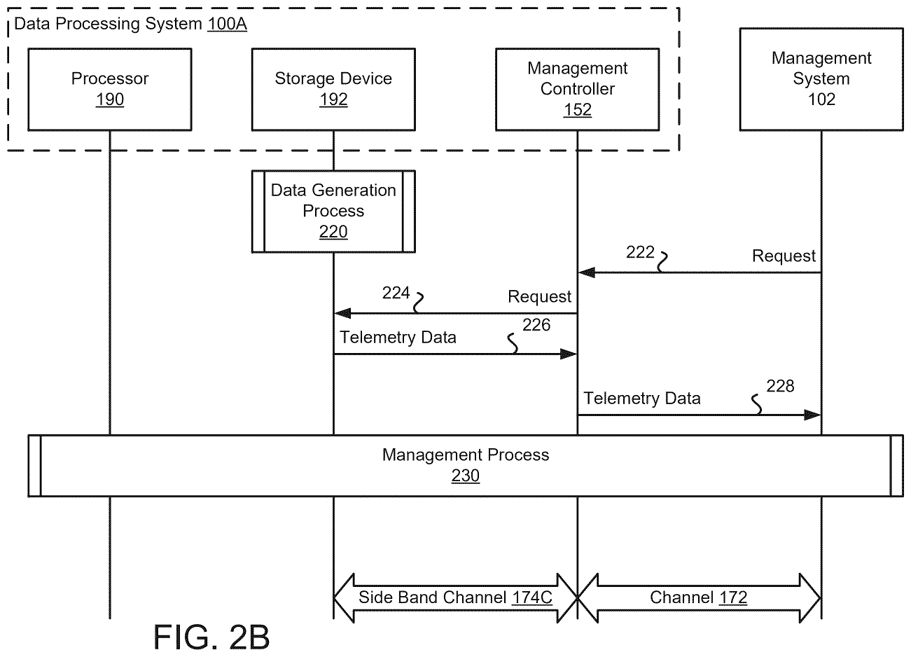

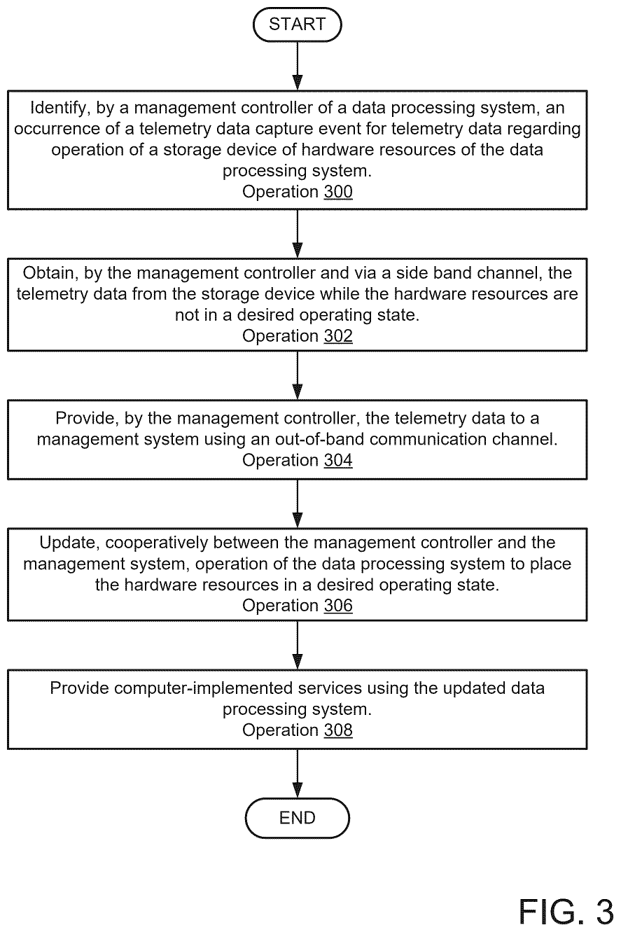

While providing their functionality, any of data processing systems 100, and management system 102 may provide all or a portion of the methods shown in FIGS. 2A-3.

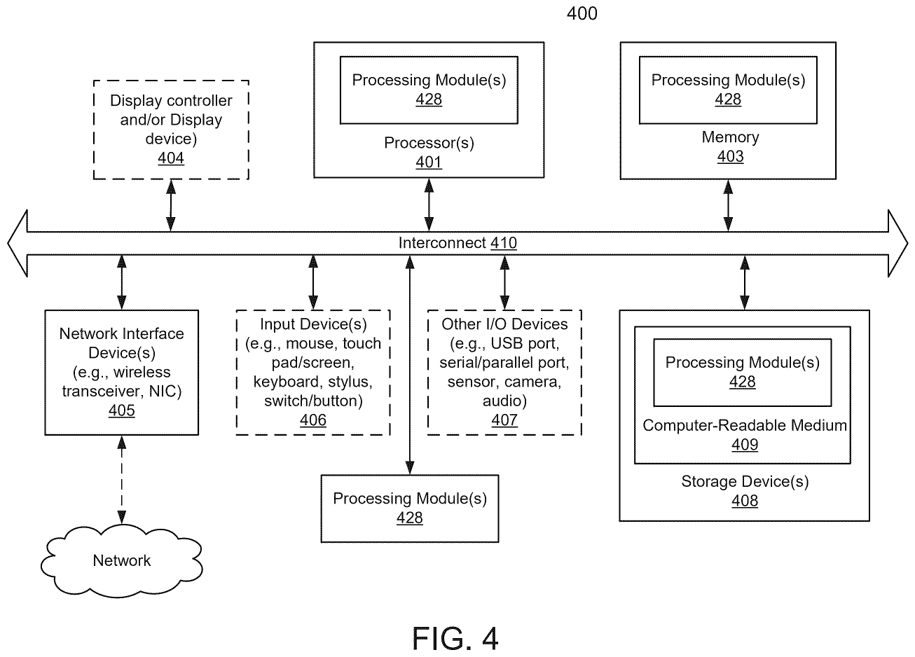

Communication system 104 may allow any of data processing systems 100, and management system 102 to communicate with one another (and/or with other devices not illustrated in FIG. 1A). To provide its functionality, communication system 104 may be implemented with one or more wired and/or wireless networks. Any of these networks may be a radio access network (e.g., a cellular core network), a private network (e.g., the “Network” shown in FIG. 4), a public network, and/or may include the Internet. For example, data processing systems 100 may be operably connected to management system 102 via the Internet. Data processing systems 100, management system 102, and/or communication system 104 may be adapted to perform one or more protocols for communicating via communication system 104.

Any of (and/or components thereof) data processing systems 100, and management system 102 may be implemented using a computing device (also referred to as a data processing system) such as a host or a server, a personal computer (e.g., desktops, laptops, and tablets), a “thin” client, a personal digital assistant (PDA), a Web enabled appliance, a mobile phone (e.g., Smartphone), an embedded system, local controllers, an edge node, and/or any other type of data processing device or system. For additional details regarding computing devices, refer to FIG. 4.

Thus, as shown in FIG. 1A, a system in accordance with an embodiment may manage operation of a data processing system by using a management controller to retrieve telemetry data regarding operation of a storage device based on a telemetry data capture event. By doing so, the telemetry data may be used to update operation of the data processing system to place the data processing system in a desired operating state.

While illustrated in FIG. 1A with a limited number of specific components, a system may include additional, fewer, and/or different components without departing from embodiments disclosed herein.

Turning to FIG. 1B, a diagram illustrating a data processing system in accordance with an embodiment is shown. Data processing system 100A shown in FIG. 1B may be similar to any of the data processing systems shown in FIG. 1A.

To provide computer-implemented services, data processing system 100A may include any quantity of hardware resources 150. Hardware resources 150 may be in-band hardware components, and may include a processor operably coupled to memory, storage, and/or other hardware components.

The storage may include any number and/or types of storage devices (e.g., hard drives, solid state drives, etc.). A storage device of the storage devices may include, for example, memory (e.g., non-volatile memory), a controller that may manage data operations (e.g., storage, retrieval, organization, etc.), and/or other physical components. The storage device may support storage protocols (e.g., non-volatile memory express) that may facilitate use of storage resources of the storage device.

For example, the storage may include a first storage device adapted to host an image of a startup management entity (e.g., basic input/output system (BIOS)), system configurations, and/or any other information. Additionally, the storage may include a second storage device that may include, but not be limited to, storage for information necessary to boot the data processing system, load an operating system for the data processing system, and/or perform any other processes.

The processor may host various management entities such as operating systems, drivers, network stacks, and/or other software entities that provide various management functionalities. For example, the operating system and drivers may provide abstracted access to various hardware resources.

To facilitate communication, hardware resources 150 may host a network stack that may facilitate packaging, transmission, routing, and/or other functions with respect to exchanging data with other devices. For example, the network stack may support transmission control protocol/internet protocol communication (TCP/IP) (e.g., the Internet protocol suite) thereby allowing hardware resources 150 to communicate with other devices via packet switched networks and/or other types of communication networks.

The processor may also host various applications that provide the computer-implemented services. The applications may utilize various services provided by the management entities and use (at least indirectly) the network stack to communication with other entities.

However, use of the network stack and the services provided by the management entities may place the applications at risk of indirect compromise. For example, if any of these entities trusted by the applications are compromised, these entities may subsequently compromise the operation of the applications. Additionally, if various drivers and/or the communication stack are compromised, communications to/from other devices may be compromised.

For example, to communicate with other entities, an application may generate and send communications to a network stack and/or driver, which may subsequently transmit a packaged form of the communication via channel 170 to a communication component, which may then send the packaged communication (in a yet further packaged form, in some embodiments, with various layers of encapsulation being added depending on the network environment outside of data processing system 100A) to another device via any number of intermediate networks (e.g., via wired/wireless channels 176 that are part of the networks).

To reduce the likelihood of the applications and/or other in-band entities from being indirectly compromised, data processing system 140 may include management controller 152 and network module 160. Each of these components of data processing system 140 is discussed below.

Management controller 152 may be implemented, for example, using a system on a chip or other type of independently operating computing device (e.g., independent from the in-band components, such as hardware resources 150, of a host data processing system 100A). Management controller 152 may provide various management functionalities for data processing system 100A. For example, management controller 152 may monitor various ongoing processes performed by the in-band components, may manage power distribution, thermal management, and/or other functions of data processing system 100A.

To provide the management functionalities, management controller 152 may utilize data that may, at least temporarily be stored on storage resources hosted by management controller 152. For example, management controller may download an image of a new management entity (e.g., firmware, application, etc.) in response to a management request, store the image, and install the new management entity using at least the image on hardware resources 150.

To do so, management controller 152 may be operably connected to various components via side band channels 174 (in FIG. 1B, a limited number of side band channels are included for illustrative purposes, it will be appreciated that management controller 152 may communication with other components via any number of side band channels). The side band channels may be implemented using separate physical channels, and/or with a logical channel overlay over existing physical channels (e.g., logical division of in-band channels). The side band channels may allow management controller 152 to interface with other components and implement various management functionalities such as, for example, general data retrieval (e.g., to snoop ongoing processes), telemetry data retrieval (e.g., to identify a health condition/other state of another component), function activation (e.g., sending instructions that cause the receiving component to perform various actions such as displaying data, adding data to memory, causing various processes to be performed), and/or other types of management functionalities.

For example, management controller 152 may identify an occurrence of an error event for a storage device, obtain information regarding a booting process performed by a processor of hardware resources 150, obtain a notification that the storage device may not be in a desired operating state, and/or perform any other management functionalities using side band channels 174.

Management controller 152 may be operably connected to communication components of data processing system 100A via separate channels (e.g., 172) from the in-band components, and may implement or otherwise utilize a distinct and independent network stack (e.g., TCP/IP). Consequently, management controller 152 may communicate with other devices independently of any of the in-band components (e.g., does not rely on any hosted software, hardware components, etc.). Accordingly, compromise of any of hardware resources 150 and hosted component may not result in indirect compromise of any management controller 152, and entities hosted by management controller 152.

For example, storage devices of hardware resources 150 may not be operably connected to a processor (e.g., due to in-band channels between the processor and the storage devices not being functional during the booting process). Management controller 152 may communicate with the processor, the boot storage device, and the storage device via side band channels 174. By doing so, management controller 152 may obtain and perform management functionalities (e.g., detecting a system hang during booting, obtaining data from a storage device, restoring boot data on the boot storage device, etc.) regardless of an operating state of hardware resources 150.

To facilitate communication with other devices, data processing system 100A may include network module 160. Network module 160 may provide communication services for in-band components and out-of-band components (e.g., management controller 152) of data processing system. To do so, network module 160 may include traffic manager 162 and interfaces 164.

Traffic manager 162 may include functionality to (i) discriminate traffic directed to various network endpoints advertised by data processing system 100A, and (ii) forward the traffic to/from the entities associated with the different network endpoints. For example, to facilitate communications with other devices, network module 160 may advertise different network endpoints (e.g., different media access control address/internet protocol addresses) for the in-band components and out-of-band components. Thus, other entities may address communications to these different network endpoints. When such communications are received by network module 160, traffic manager 162 may discriminate and direct the communications accordingly (e.g., over channel 170 or channel 172, in the example shown in FIG. 1B, it will be appreciated that network module 160 may discriminate traffic directed to any number of data units and direct it accordingly over any number of channels).

Accordingly, traffic directed to management controller 152 may never flow through any of the in-band components. Likewise, outbound traffic from the out-of-band component may never flow through the in-band components.

Therefore, management controller 152 may communicate the telemetry data regarding operation of the storage device to management system 102, obtain a remediation package from management system 102, and/or cooperatively perform any other management functionalities via communication of information using an out-of-band communication channel (e.g., channel 172).

To support inbound and outbound traffic, network module 160 may include any number of interfaces 164. Interfaces 164 may be implemented using any number and type of communication devices which may each provide wired and/or wireless communication functionality. For example, interfaces 164 may include a wide area network card, a WiFi card, a wireless local area network card, a wired local area network card, an optical communication card, and/or other types of communication components. These components may support any number of wired/wireless channels 176.

Thus, from the perspective of an external device, the in-band components and out-of-band components of data processing system 100A may appear to be two independent network entities, that may independently addressable, and otherwise unrelated to one another.

To facilitate management of data processing system 100A over time, hardware resources 150, management controller 152 and/or network module 160 may be positioned in separately controllable power domains. By being positioned in these separately controllable power domains, different subsets of these components may remain powered while other subsets are unpowered.

For example, management controller 152 and network module 160 may remain powered while hardware resources 150 is unpowered. Consequently, management controller 152 may remain able to communication with other devices even while hardware resources 150 are inactive. Similarly, management controller 152 may perform various actions while hardware resources 150 are not powered and/or are otherwise inoperable, unable to cooperatively perform various process, are compromised, and/or are unavailable for other reasons.

To implement the separate power domains, data processing system 100A may include a power source (e.g., 180) that separately supplies power to power rails (e.g., 184, 186) that power the respective power domains. Power from the power source (e.g., a power supply, battery, etc.) may be selectively provided to the separate power rails to selectively power the different power domains. A power manager (e.g., 182) may manage power from power source 180 that is supplied to the power rails. Management controller 152 may cooperate with power manager 182 to manage supply of power to these power domains.

In FIG. 1B, an example implementation of separate power domains using power rails 184-186 is shown. The power rails may be implemented using, for example, bus bars or other types of transmission elements capable of distributing electrical power. While not shown, it will be appreciated that the power domains may include various power management components (e.g., fuses, switches, etc.) to facilitate selective distribution of power within the power domains.

When providing its functionality, management controller 152 may perform all, or a portion, of the methods and operations illustrated in FIGS. 2A-3.

While illustrated in FIG. 1B with a limited number of specific components, a system may include additional, fewer, and/or different components without departing from embodiments disclosed herein.

Turning to FIG. 1C, to provide computer-implemented services, hardware resources 150 may host processor 190, boot storage device 191, and storage device 192. For example, to place a data processing system (e.g., 100A) in a desired operating state, data processing system 100A may perform a booting process to initialize hardware resources and facilitate operation of an operating system. To do so, processor 190 may execute instructions indicated by boot data (e.g., firmware, system configuration, etc.) hosted by boot storage device 191.

Boot storage device 191 may include, for example, non-volatile flash memory (e.g., serial peripheral interface (SPI) flash) that may be hosted on a motherboard and adapted to store information, such as firmware, an image of a management entity (BIOS, unified extensible firmware interface (UEFI), etc.), system configuration files, and/or any other information usable to boot data processing system 100A. Because boot storage device 191 may have a limited storage capacity, storage device 192 may be used to store additional information (e.g., other copies of boot data).

Storage device 192 may include, for example, a second storage device such as a non-volatile memory express (NVMe) based solid-state drive. Storage device 192 may include a boot partition (193) that may be configured to store data usable to boot data processing system 100A (e.g., a desired of boot data, bootloader files, configuration files, etc.). Boot partition 193 may include an allocated section of storage device 192 that may, for example, be isolated from other memory sections of storage device 192. Furthermore, to provide its functionality, storage device 192 may include storage resources (e.g., flash memory cells), a controller (e.g., to manage operations of the storage device), an interface (e.g., to facilitate communication between the storage device and the processor), and/or any other components.

While operating, storage device 192 may generate data (e.g., telemetry data) regarding operation of storage device 192. The telemetry data may include, for example, error logs, storage device health data, performance metrics, and/or any other information. The telemetry data may be used to manage operation of the storage device 192 and/or other components of data processing system.

Processor 190 may include a central processing unit (CPU) that may interact with any number and/or type of other hardware components (e.g., boot storage device 191, storage device 192, and hardware components 195). For example, when data processing system 100A is powered on, processor 190 may be initialized to a predetermined state and directed to retrieve instructions (e.g., via a reset vector) from boot storage device 191. To interact with boot storage device 191, storage device 192, and/or the other hardware components, processor 190 may be operably connected to each of the components via in-band channels 171.

However, at least a portion of in-band channels 171 may not be functional and/or may have reduced functionality during booting of data processing system 100A and/or as a result of an error event that may prevent completion of the booting. For example, in an event that storage device 192 and/or hardware components 195 are not initialized during booting, processor 190 may not be able to communicate with storage device 192 to obtain data required to place data processing system 100A in a desired operating state.

Thus, to improve a likelihood that data processing system 100A may be booted and placed in the desired operating state, management controller 152 may perform management functionalities using any number and/or type of side band channels (e.g. 174). For example, management controller may obtain information (e.g., telemetry data, process results, boot times, etc.) regarding operation of storage device 192 from processor 190 using side band channel 174A, replace a copy of undesired boot data hosted by boot storage device 191 with a desired copy of boot data using side band channel 174B, retrieve telemetry data regarding operation of storage device 192 from storage device 192 using side band channel 174C, and/or perform any other actions by communicating with components of hardware resources regardless of an operating status of hardware resources 150.

To further clarify embodiments disclosed herein, interaction diagrams in accordance with an embodiment are shown in FIGS. 2A-2B. The interaction diagrams may illustrate how data may be obtained and used within the system of FIGS. 1A-1C.

In the interaction diagrams, processes performed by and interactions between components of a system in accordance with an embodiment are shown. In the diagrams, components of the system are illustrated using a first set of shapes (e.g., 190, 191, etc.), located towards the top of each figure. Lines descend from these shapes. Processes performed by the components of the system are illustrated using a second set of shapes (e.g., 200, 210, etc.) superimposed over these lines. Interactions (e.g., communication, data transmissions, etc.) between the components of the system are illustrated using a third set of shapes (e.g., 202, 204, etc.) that extend between the lines. The third set of shapes may include lines terminating in one or two arrows. Lines terminating in a single arrow may indicate that one way interactions (e.g., data transmission from a first component to a second component) occur, while lines terminating in two arrows may indicate that multi-way interactions (e.g., data transmission between two components) occur.

Generally, the processes and interactions are temporally ordered in an example order, with time increasing from the top to the bottom of each page. For example, the process labeled as 200 may occur prior to the interaction labeled as 202. However, it will be appreciated that the processes and interactions may be performed in different orders, any may be omitted, and other processes or interactions may be performed without departing from embodiments disclosed herein.

Turning to FIG. 2A, a first interaction diagram in accordance with an embodiment is shown. The first interaction diagram may illustrate processes and interactions that may occur during management of a data processing system based on telemetry data retrieved from a storage device and based on operation of the storage device.

To manage operation of the data processing system, booting process 200 may be performed. During booting process 200, processor 190 may attempt to boot data processing system 100A, and management controller 152 may identify a telemetry data capture event based on the booting process. For example, processor 190 may attempt to boot data processing system 100A by executing instructions (e.g., firmware code) indicated by boot data hosted by a boot storage device (e.g., 191, not shown), performing a power-on self-test to verify and/or initialize at least a portion of the hardware resources, attempting to load an operating system into memory, and/or performing any other actions.

While attempting to boot, processor 190 may be attempt to establish a communication channel (e.g., in band channel 171A) with storage device 192. In-band channel 171A may include, for example, a limited communication channel between processor 190 and storage device 192 that may be facilitated using a communication interface (e.g., serial advanced technology attachment (SATA), peripheral component interconnect express (PCIe), etc.) and/or a data transfer protocol (e.g., NVMe).

However, in band channel 171A (shown in dashed lines) may not be successfully established due to an error event that may prevent desired operation of storage device 192. The error event may be identified, for example, by processor 190 (e.g., using basic input/output system (BIOS) firmware) and the error event may be based on a boot failure (e.g., CPU hang), an SSD initialization failure, a self-monitoring and reporting technology (SMART) error, data corruption, and/or any other events.

Accordingly, management controller 152 identify a telemetry data capture event during the attempted booting of data processing system 100A. To do so, management controller 152 may monitor and/or obtain information from processor 190 using side band channel 174A. For example, management controller 152 may obtain data processing results from processor 190, compare the results to criteria (e.g., a boot timeout time), and/or perform any other actions to determine that an error event (e.g., a system hang) has occurred.

At interaction 202, a notification may be provided to management controller 152. The notification may be provided to management controller 152 via: (i) transmission of a message from processor 190 that indicates a request for management controller 152 to retrieve the telemetry data from storage device 192, (ii) evaluation of information obtained during monitoring of booting process 200, and/or any other processes.

At interaction 204, a request for the telemetry data may be provided to storage device 192 by management controller 152. The request may be provided by querying the storage resources of storage device 192 for telemetry data using a data transfer protocol command, issuing a read request using side band channel 174C, and/or performing any other actions.

At interaction 206, the telemetry data may be provided to management controller 152 by storage device 192. For example, the telemetry data may be provided by: (i) locating the requested telemetry data (e.g., on storage resources of a controller of storage device 192, flash memory cells of storage device 192, etc.), (ii) transferring the requested boot data to management controller via side band channel 174C and/or using a data transfer protocol (e.g., NVMe, etc.), and/or via any other processes. The telemetry data may include, for example, error logs, storage device health data, performance metrics, and/or any other information.

At interaction 208, the telemetry data may be provided to management system 102 by management controller 152. The telemetry data may be provided to management system 102 by: (i) transmitting at least a copy of the telemetry data to management system 102 as a message using an out-of-band communication channel (e.g., channel 172), (ii) uploading the copy of the telemetry data to storage for subsequent retrieval and/or access by management system 102, and/or via any other processes.

Channel 172 may include an out-of-band communication channel that may enable communication between management controller 152 and management system 102. For example, because management controller 152 may operate independently of the in-band components of the hardware resources and may utilize a separate network endpoint via a network module of data processing system 100A, management controller 152 may communicate the telemetry data to management system 102 regardless of an operating state of hardware resources of data processing system 100A. To do so, channel 172 may utilize a transmission control/internet protocol (TCP/IP) stack to facilitate network communications via the out-of-band communication channel.

To update operation of data processing system 100A based, at least in part, on the telemetry data, management process 210 may be performed. During management process 210, a remediation package may be obtained based on the telemetry data, and operation of the data processing system may be updated using the remediation package. For example, to obtain the remediation package, management system 102 may evaluate the telemetry data to obtain an evaluation result, compare the telemetry data to criteria, search a repository based on the evaluation result, and/or perform any other actions. The remediation package may include, for example, instructions to be executed, updated storage device firmware, data recovery information, and/or any other information. The remediation package may subsequently be provided to management controller 152 via channel 172.

Once obtained, the remediation package may be used by management controller 152 to update operation of storage device 192 and/or other hardware resources. For example, management controller 152 may install new software based on the remediation package, depower and/or reduce functionality of storage device 192, initiate a data recovery process, initiate a new booting process by processor 190, and/or perform any other actions to update operation of data processing system 100A using the remediation package. To do so, management controller may communicate with processor 190 using side band channel 174A.

By executing the instructions provided by management controller 152 and/or based on the remediation package, processor 190 may perform operations that may place data processing system 100A in a desired state. For example, storage device 192 may be reconfigured, new images of management software may be installed, and/or any other actions may be performed.

Side band channels (e.g., 174A, 174C) may be used to facilitate communication between management controller 152 and storage device 192, and are shown to indicate that management controller 152 may interface with processor 190, and storage device 192 regardless of a status of in-band channels (e.g., that may have reduced functionality due to the undesired boot event). Using the side band channels, management controller 152 may perform management commands that may include, for example, accessing telemetry data regarding operation of storage device 192, installing management entities on hardware resources 150 using a remediation package, and/or performing any other actions.

Thus, using processes and interactions shown in FIG. 2A, telemetry data regarding operation of a storage device may be retrieved by a management controller based on an occurrence of a telemetry data capture event. The telemetry data may be provided to a remote management entity and used to obtain a remediation package for use in updating operation of the data processing system by the management controller. By doing so, the data processing system may be placed in a desired operating state for providing computer-implemented services.

Turning to FIG. 2B, a second interaction diagram in accordance with an embodiment is shown. The second interaction diagram may illustrate processes and interactions that may occur during management of a data processing system based on a request from a remote management system to receive telemetry data regarding operation of a storage device of the data processing system.

To manage operation of the data processing system using the telemetry data, data generation process 220 may be performed. During data generation process 220, operation of storage device 192 may be monitored, and the telemetry data regarding the operation may be stored on storage device 192. For example, to monitor operation of storage device 192, storage device 192 may utilize sensors that may record device health and performance metrics, an internal controller of storage device 192 may collect the telemetry data generated by the sensors and/or other components, the controller may initiate generation of telemetry logs (e.g., that may include controller activity, interactions with a host system, critical error logs, etc.), and/or via any other processes. The telemetry data may subsequently be stored on storage hosted by the controller and/or storage resources (e.g., flash memory cells) of storage device 192.

At interaction 222, a request for the telemetry data may be provided to management controller 152 by management system 102. For example, the request may be issued to management controller as a message using an out-of-band communication channel (e.g., channel 172), based on a previously configured data reporting policy, and/or any other processes.

At interaction 224, a second request for the telemetry data may be provided to storage device 192 by management controller 152. The request may be provided by querying the storage resources of storage device 192 for telemetry data using a data transfer protocol command, issuing a read request using side band channel 174C, and/or performing any other actions.

At interaction 226, the telemetry data may be provided to management controller 152 by storage device 192. For example, the telemetry data may be provided by: (i) locating the requested telemetry data (e.g., on storage resources of a controller of storage device 192, flash memory cells of storage device 192, etc.), (ii) transferring the requested boot data to management controller via side band channel 174C and/or using a data transfer protocol (e.g., NVMe, etc.), and/or via any other processes. The telemetry data may include, for example, error logs, storage device health data, performance metrics, and/or any other information.

At interaction 228, the telemetry data may be provided to management system 102 by management controller 152. The telemetry data may be provided to management system 102 by: (i) transmitting at least a copy of the telemetry data to management system 102 as a message using an out-of-band communication channel (e.g., channel 172), (ii) uploading the copy of the telemetry data to storage for subsequent retrieval and/or access by management system 102, and/or via any other processes.

As previously discussed in FIG. 2A, management process 210 may be performed to update operation of data processing system 100A based, at least in part on the telemetry data regarding operation of storage device 192. For example, consider a scenario in which the telemetry data indicates that storage device 192 is underperforming (e.g., a read/write speed that may be 50 percent of a desired read/write speed, prolonged average latency of the storage device, and/or any other performance indicators). Management system 102 and/or management controller 152 may perform diagnostic testing using the telemetry data to obtain a remediation package that may include, for example, updated SSD drivers, enable caching, reconfigure an operating mode, and/or perform any other actions to improve a performance of storage device 192.

Consider a second scenario in which management system 102 identifies that the telemetry data indicates that data processing system 100A may be in a potentially compromised state (e.g., infected by malware). Management controller 152 may obtain a remediation package from management system 102 and perform, based on the remediation package, a reconfiguration of the storage device that may include, for example, creating a backup of data stored on storage device 192, storing (e.g., at least temporarily) the data on storage resources of management controller 152, erasing the data from storage device 192, initializing a reset of storage device 192, restricting access to storage device 192, requesting additional information from processor 190, and/or performing any other actions.

Thus, using processes and interactions shown in FIG. 2B, telemetry data regarding operation of a storage device may be provided to a remote management entity based on a request from the remote management entity. The remote management entity may, cooperatively with the management controller, update operation of the storage device and/or other hardware resources of the data processing system based on the telemetry data.

Any of the processes illustrated using the second set of shapes and interactions illustrated using the third set of shapes may be performed, in part or whole, by digital processors (e.g., central processors, processor cores, etc.) that execute corresponding instructions (e.g., computer code/software). Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes and interactions illustrated using the third set of shapes may be performed, in part or whole, by special purpose hardware components such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor based devices (e.g., computer chips).

Any of the processes and interactions may be implemented using any type and number of data structures. The data structures may be implemented using, for example, tables, lists, linked lists, unstructured data, data bases, and/or other types of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

As discussed above, the components of FIGS. 1A-1C may perform various methods to manage a data processing system. FIG. 3 illustrate methods that may be performed by the components of the system of FIGS. 1A-1C. In the diagrams discussed below and shown in FIG. 3, any of the operations may be repeated, performed in different orders, and/or performed in parallel with or in a partially overlapping in time manner with other operations.

Turning to FIG. 3, a flow diagram illustrating a method of managing operation of a data processing system in accordance with an embodiment is shown. The method may be performed, for example, by any of the components of the system of FIGS. 1A-1C, and/or other components not shown therein.

At operation 300, an occurrence of a telemetry data capture event for telemetry data regarding operation of a storage device of hardware resources of the data processing system may be identified. The occurrence of the telemetry data capture event may be identified by a management controller of the data processing system. Because in-band channels may have limited functionality during the booting and/or as a result of an error event preventing completion of the booting, the management controller may obtain information (e.g., telemetry data, results of processes performed, etc.) regarding the booting from a processor of the data processing system using a side band channel. Management controller 152 may detect that a system hang (e.g., a boot timeout) based on the information, receive a notification from the processor while the data processing system attempts to boot, be configured to report data to a remote management system, and/or be triggered to capture the telemetry data from the storage device via any other processes.

At operation 302, the management controller may obtain the telemetry data from the storage device. The telemetry data may be obtained by (i) transmitting a read request (e.g., an identifier, file address, etc.) to the storage device for the telemetry data, (ii) locating, by the storage device, the requested telemetry data, (iii) transmitting the telemetry data via the side band channel and/or using a data transfer protocol (e.g., NVMe), validating an integrity of the telemetry data, and/or via any other processes.

At operation 304, the telemetry data may be provided to a management system using an out-of-band communication channel. The management controller may provide the telemetry data to the management system by: (i) communicating the telemetry data as a message using a communication protocol (e.g., TCP/IP), (ii) uploading the telemetry data to a shared repository that may be accessed by the management system, and/or via any other processes.

At operation 306, operation of the data processing system may be cooperatively updated by the management controller and the management system to place the hardware resources in a desired operating state. The operation may be updated by: (i) identifying a remediation package (e.g., updated firmware/drivers for the storage device, instructions to depower the storage device, request for additional information, etc.) based on the telemetry data, (ii) issuing commands to the processor by the management controller to modify functionality of the storage device, (iii) interfacing with the storage device to install the new firmware, and/or performing any other actions.

At operation 308, computer-implemented services may be provided by the data processing system and while in the desired operating state. The computer-implemented services may be provided by: (i) installing a new management entity (e.g., an application, driver, firmware etc.), (ii) providing storage resources by the storage device to support desired computer-implemented services, and/or via any other processes.

The method may end following operation 308.

Using the method shown in FIG. 3, operation of a data processing system may be managed using a management controller to retrieve telemetry data regarding operation of a storage device. The telemetry data may be provided to a remote management system and used to identify an update to the storage device. By doing so, the storage device may be updated to facilitate provisioning of desired computer-implemented services by the data processing system.

Any of the components illustrated in FIGS. 1A-2B may be implemented with one or more computing devices. Turning to FIG. 4, a block diagram illustrating an example of a data processing system (e.g., a computing device) in accordance with an embodiment is shown. For example, system 400 may represent any of data processing systems described above performing any of the processes or methods described above. System 400 can include many different components. These components can be implemented as integrated circuits (ICs), portions thereof, discrete electronic devices, or other modules adapted to a circuit board such as a motherboard or add-in card of the computer system, or as components otherwise incorporated within a chassis of the computer system. Note also that system 400 is intended to show a high level view of many components of the computer system. However, it is to be understood that additional components may be present in certain implementations and furthermore, different arrangement of the components shown may occur in other implementations. System 400 may represent a desktop, a laptop, a tablet, a server, a mobile phone, a media player, a personal digital assistant (PDA), a personal communicator, a gaming device, a network router or hub, a wireless access point (AP) or repeater, a set-top box, or a combination thereof. Further, while only a single machine or system is illustrated, the term “machine” or “system” shall also be taken to include any collection of machines or systems that individually or jointly execute a set (or multiple sets) of instructions to perform any one or more of the methodologies discussed herein.

In one embodiment, system 400 includes processor 401, memory 403, and devices 405-407 via a bus or an interconnect 410. Processor 401 may represent a single processor or multiple processors with a single processor core or multiple processor cores included therein. Processor 401 may represent one or more general-purpose processors such as a microprocessor, a central processing unit (CPU), or the like. More particularly, processor 401 may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 401 may also be one or more special-purpose processors such as an application specific integrated circuit (ASIC), a cellular or baseband processor, a field programmable gate array (FPGA), a digital signal processor (DSP), a network processor, a graphics processor, a network processor, a communications processor, a cryptographic processor, a co-processor, an embedded processor, or any other type of logic capable of processing instructions.

Processor 401, which may be a low power multi-core processor socket such as an ultra-low voltage processor, may act as a main processing unit and central hub for communication with the various components of the system. Such processor can be implemented as a system on chip (SoC). Processor 401 is configured to execute instructions for performing the operations discussed herein. System 400 may further include a graphics interface that communicates with optional graphics subsystem 404, which may include a display controller, a graphics processor, and/or a display device.

Processor 401 may communicate with memory 403, which in one embodiment can be implemented via multiple memory devices to provide for a given amount of system memory. Memory 403 may include one or more volatile storage (or memory) devices such as random access memory (RAM), dynamic RAM (DRAM), synchronous DRAM (SDRAM), static RAM (SRAM), or other types of storage devices. Memory 403 may store information including sequences of instructions that are executed by processor 401, or any other device. For example, executable code and/or data of a variety of operating systems, device drivers, firmware (e.g., input output basic system or BIOS), and/or applications can be loaded in memory 403 and executed by processor 401. An operating system can be any kind of operating systems, such as, for example, Windows® operating system from Microsoft®, Mac OS®/iOS® from Apple, Android® from Google®, Linux®, Unix®, or other real-time or embedded operating systems such as VxWorks.

System 400 may further include IO devices such as devices (e.g., 405, 406, 407, 408) including network interface device(s) 405, optional input device(s) 406, and other optional IO device(s) 407. Network interface device(s) 405 may include a wireless transceiver and/or a network interface card (NIC). The wireless transceiver may be a WiFi transceiver, an infrared transceiver, a Bluetooth transceiver, a WiMax transceiver, a wireless cellular telephony transceiver, a satellite transceiver (e.g., a global positioning system (GPS) transceiver), or other radio frequency (RF) transceivers, or a combination thereof. The NIC may be an Ethernet card.

Input device(s) 406 may include a mouse, a touch pad, a touch sensitive screen (which may be integrated with a display device of optional graphics subsystem 404), a pointer device such as a stylus, and/or a keyboard (e.g., physical keyboard or a virtual keyboard displayed as part of a touch sensitive screen). For example, input device(s) 406 may include a touch screen controller coupled to a touch screen. The touch screen and touch screen controller can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch screen.

IO devices 407 may include an audio device. An audio device may include a speaker and/or a microphone to facilitate voice-enabled functions, such as voice recognition, voice replication, digital recording, and/or telephony functions. Other IO devices 407 may further include universal serial bus (USB) port(s), parallel port(s), serial port(s), a printer, a network interface, a bus bridge (e.g., a PCI-PCI bridge), sensor(s) (e.g., a motion sensor such as an accelerometer, gyroscope, a magnetometer, a light sensor, compass, a proximity sensor, etc.), or a combination thereof. IO device(s) 407 may further include an imaging processing subsystem (e.g., a camera), which may include an optical sensor, such as a charged coupled device (CCD) or a complementary metal-oxide semiconductor (CMOS) optical sensor, utilized to facilitate camera functions, such as recording photographs and video clips. Certain sensors may be coupled to interconnect 410 via a sensor hub (not shown), while other devices such as a keyboard or thermal sensor may be controlled by an embedded controller (not shown), dependent upon the specific configuration or design of system 400.

To provide for persistent storage of information such as data, applications, one or more operating systems and so forth, a mass storage (not shown) may also couple to processor 401. In various embodiments, to enable a thinner and lighter system design as well as to improve system responsiveness, this mass storage may be implemented via a solid state device (SSD). However, in other embodiments, the mass storage may primarily be implemented using a hard disk drive (HDD) with a smaller amount of SSD storage to act as an SSD cache to enable non-volatile storage of context state and other such information during power down events so that a fast power up can occur on re-initiation of system activities. Also a flash device may be coupled to processor 401, e.g., via a serial peripheral interface (SPI). This flash device may provide for non-volatile storage of system software, including a basic input/output software (BIOS) as well as other firmware of the system.

Storage device 408 may include computer-readable storage medium 409 (also known as a machine-readable storage medium or a computer-readable medium) on which is stored one or more sets of instructions or software (e.g., processing module, unit, and/or processing module/unit/logic 428) embodying any one or more of the methodologies or functions described herein. Processing module/unit/logic 428 may represent any of the components described above. Processing module/unit/logic 428 may also reside, completely or at least partially, within memory 403 and/or within processor 401 during execution thereof by system 400, memory 403 and processor 401 also constituting machine-accessible storage media. Processing module/unit/logic 428 may further be transmitted or received over a network via network interface device(s) 405.

Computer-readable storage medium 409 may also be used to store some software functionalities described above persistently. While computer-readable storage medium 409 is shown in an exemplary embodiment to be a single medium, the term “computer-readable storage medium” should be taken to include a single medium or multiple media (e.g., a centralized or distributed database, and/or associated caches and servers) that store the one or more sets of instructions. The terms “computer-readable storage medium” shall also be taken to include any medium that is capable of storing or encoding a set of instructions for execution by the machine and that cause the machine to perform any one or more of the methodologies of embodiments disclosed herein. The term “computer-readable storage medium” shall accordingly be taken to include, but not be limited to, solid-state memories, and optical and magnetic media, or any other non-transitory machine-readable medium.

Processing module/unit/logic 428, components and other features described herein can be implemented as discrete hardware components or integrated in the functionality of hardware components such as ASICS, FPGAs, DSPs or similar devices. In addition, processing module/unit/logic 428 can be implemented as firmware or functional circuitry within hardware devices. Further, processing module/unit/logic 428 can be implemented in any combination hardware devices and software components.

Note that while system 400 is illustrated with various components of a data processing system, it is not intended to represent any particular architecture or manner of interconnecting the components; as such details are not germane to embodiments disclosed herein. It will also be appreciated that network computers, handheld computers, mobile phones, servers, and/or other data processing systems which have fewer components or perhaps more components may also be used with embodiments disclosed herein.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as those set forth in the claims below, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments disclosed herein also relate to an apparatus for performing the operations herein. Such a computer program is stored in a non-transitory computer readable medium. A non-transitory machine-readable medium includes any mechanism for storing information in a form readable by a machine (e.g., a computer). For example, a machine-readable (e.g., computer-readable) medium includes a machine (e.g., a computer) readable storage medium (e.g., read only memory (“ROM”), random access memory (“RAM”), magnetic disk storage media, optical storage media, flash memory devices).

The processes or methods depicted in the preceding figures may be performed by processing logic that comprises hardware (e.g. circuitry, dedicated logic, etc.), software (e.g., embodied on a non-transitory computer readable medium), or a combination of both. Although the processes or methods are described above in terms of some sequential operations, it should be appreciated that some of the operations described may be performed in a different order. Moreover, some operations may be performed in parallel rather than sequentially.

Embodiments disclosed herein are not described with reference to any particular programming language. It will be appreciated that a variety of programming languages may be used to implement the teachings of embodiments disclosed herein.

In the foregoing specification, embodiments have been described with reference to specific exemplary embodiments thereof. It will be evident that various modifications may be made thereto without departing from the broader spirit and scope of the embodiments disclosed herein as set forth in the following claims. The specification and drawings are, accordingly, to be regarded in an illustrative sense rather than a restrictive sense.

1. A method of managing operation of a data processing system, the method comprising:
identifying, by a management controller of the data processing system, an occurrence of a telemetry data capture event for telemetry data regarding operation of a storage device of hardware resources of the data processing system, wherein the data processing system comprises a network module adapted to separately advertise network endpoints for the management controller and the hardware resources of the data processing system, the network endpoints being usable by a remote system to address communications to the hardware resources using an in-band communication channel and the management controller using an out-of-band communication channel;
in response to the telemetry data capture event:
obtaining, by the management controller via a side band channel, the telemetry data from the storage device while the hardware resources are not in a desired operating state;
providing, by the management controller, the telemetry data to a management system using an out-of-band communication channel;
updating, cooperatively between the management controller and the management system, operation of the data processing system to place the hardware resources in a desired operating state; and
providing, after updating the data processing system, computer-implemented services using the data processing system.

2. The method of claim 1, wherein the telemetry data capture event is based on an inability of a processor of the hardware resources to access data hosted by the storage device while the data processing system is booting, the data hosted by the storage device being required for completion of a startup of the data processing system.

3. The method of claim 2, wherein identifying the occurrence of the telemetry data capture event comprises:
identifying, by the processor, an occurrence of an error event for the storage device, the error event preventing desired operation of the storage device; and
identifying, by the management controller, that the processor is unable to complete a startup of the data processing system due to the occurrence of the error event.

4. The method of claim 1, wherein the telemetry data is:
generated by the storage device based on operation of the storage device, and stored on the storage device.

5. The method of claim 1, wherein the telemetry data comprises at least one type of data selected from a group consisting of:
error logs;
storage device health data; and
performance metrics.

6. The method of claim 1, wherein updating the operation of the data processing system comprises:
obtaining, by the management controller and from the management system, a remediation package via the out-of-band communication channel, the remediation package being based, at least in part, on the telemetry data; and
updating, by the management controller, operation of the data processing system using the remediation package.

7. (canceled)

8. The method of claim 1, wherein the management controller and the network module are on separate power domains from the hardware resources so that the management controller and the network module are operable while the hardware resources are inoperable.

9. The method of claim 1, wherein the out-of-band communication channel runs through the network module, and an in-band communication channel that services the hardware resources also runs through the network module.

10. The method of claim 1, wherein the network module hosts a transmission control protocol/internet protocol (TCP/IP) stack to facilitate network communications via the out-of-band communication channel.

11. A non-transitory machine-readable medium having instructions stored therein, which when executed by a processor, cause the processor to perform operations for managing operation of a data processing system, the operations comprising:
identifying, by a management controller of the data processing system, an occurrence of a telemetry data capture event for telemetry data regarding operation of a storage device of hardware resources of the data processing system, wherein the data processing system comprises a network module adapted to separately advertise network endpoints for the management controller and the hardware resources of the data processing system, the network endpoints being usable by a remote system to address communications to the hardware resources using an in-band communication channel and the management controller using an out-of-band communication channel;
in response to the telemetry data capture event:
obtaining, by the management controller via a side band channel, the telemetry data from the storage device while the hardware resources are not in a desired operating state;
providing, by the management controller, the telemetry data to a management system using an out-of-band communication channel;
updating, cooperatively between the management controller and the management system, operation of the data processing system to place the hardware resources in a desired operating state; and
providing, after updating the data processing system, computer-implemented services using the data processing system.

12. The non-transitory machine-readable medium of claim 11, wherein the telemetry data capture event is based on an inability of a processor of the hardware resources to access data hosted by the storage device while the data processing system is booting, the data hosted by the storage device being required for completion of a startup of the data processing system.

13. The non-transitory machine-readable medium of claim 12, wherein identifying the occurrence of the telemetry data capture event comprises:
identifying, by the processor, an occurrence of an error event for the storage device, the error event preventing desired operation of the storage device; and
identifying, by the management controller, that the processor is unable to complete a startup of the data processing system due to the occurrence of the error event.

14. The non-transitory machine-readable medium of claim 11, wherein the telemetry data is:
generated by the storage device based on operation of the storage device, and stored on the storage device.

15. The non-transitory machine-readable medium of claim 11, wherein the telemetry data comprises at least one type of data selected from a group consisting of:
error logs;
storage device health data; and
performance metrics.

16. A system, comprising:
a processor; and
a memory coupled to the processor to store instructions, which when executed by the processor, cause the processor to perform operations for managing operation of a data processing system, the operations comprising:
identifying, by a management controller of the data processing system, an occurrence of a telemetry data capture event for telemetry data regarding operation of a storage device of hardware resources of the data processing system, wherein the data processing system comprises a network module adapted to separately advertise network endpoints for the management controller and the hardware resources of the data processing system, the network endpoints being usable by a remote system to address communications to the hardware resources using an in-band communication channel and the management controller using an out-of-band communication channel;
in response to the telemetry data capture event:
obtaining, by the management controller via a side band channel, the telemetry data from the storage device while the hardware resources are not in a desired operating state;
providing, by the management controller, the telemetry data to a management system using an out-of-band communication channel;
updating, cooperatively between the management controller and the management system, operation of the data processing system to place the hardware resources in a desired operating state; and
providing, after updating the data processing system, computer-implemented services using the data processing system.

17. The system of claim 16, the telemetry data capture event is based on an inability of a processor of the hardware resources to access data hosted by the storage device while the data processing system is booting, the data hosted by the storage device being required for completion of a startup of the data processing system.

18. The system of claim 17, wherein identifying the occurrence of the telemetry data capture event comprises:
identifying, by the processor, an occurrence of an error event for the storage device, the error event preventing desired operation of the storage device; and
identifying, by the management controller, that the processor is unable to complete a startup of the data processing system due to the occurrence of the error event.

19. The system of claim 16, wherein the telemetry data is:
generated by the storage device based on operation of the storage device, and stored on the storage device.

20. The system of claim 16, wherein the telemetry data comprises at least one type of data selected from a group consisting of:
error logs;
storage device health data; and
performance metrics.

21. The system of claim 16, wherein the management controller and the network module are on separate power domains from the hardware resources so that the management controller and the network module are operable while the hardware resources are inoperable.
